(19) United States
(12) Patent Application Publication
(10) Pub. No.: US 2003/0133235 A1
(43) Pub. Date: Jul. 17, 2003

(54) Food texture control and protection system for electric motor powered blender

(76) Inventors: Siu Yim Yung, Hong Kong (HK); Man Fai Lun, Hong Kong (HK)

Correspondence Address: MAN FAI LUN, ROOM 1612, GRANDTECH CENTRE, 8 ON PING STREET, SHATIN, N.T., HONG KONG, HK

(21) Appl. No.: 10/047,879

(22) Filed: Jan. 14, 2002

(51) Int. Cl. H02H 5/04

(52) U.S. Cl. 361/23; 318/245

(57) ABSTRACT

A food texture control and protection system for electric motor powered blender includes a device adapted to receive a selection signal that is generated by input device. The device controls the speed of the blade according to a selected speed variation against time curve aiming at to provide variation in the food texture. The device controls the blender by phase controlling the power supply to the motor of the blender. Since the device controls the power supply up to every half cycle, it provides an effective means to control as well as to protect the motor; the introduction of a soft start sequence to the phase control device for the series-wound universal motor during start up effectively provides sufficient energy for the generation of the magnetic flux without driving the motor to magnetic saturation or resistive power dissipation that caused from excessive current; upon the detection of the improper operating condition by tracking the operating condition with fast respond physical sensors the device turns off the power supply. A motor working under improper condition may have its life shortened caused by the accumulative damages due to ineffective overload protection. In some embodiments, curve selection may be performed automatically by the device computation algorithm that computes from the data obtained by the sensors tracing the food texture related physical quantities.

### FIELD OF THE INVENTION

The present invention relates to a food texture control and protection system for electric motor powered blender and more specifically to a food texture control and protection system for electric motor powered blender that generate different food textures basing on speed variation against time curves and protect the electric motor basing on start up current control and physical signal sensing.

### BACKGROUND OF THE INVENTION

A blender powered by electric motor mainly requires two types of controls. The first one is the speed control that sets the required operation speed for different food texture. The second one is the protection control that protects the electric motor from overloading.

Various electric motors can be used to power the blender. However, series-wound universal motor is commonly used due to its torque characteristic at various speeds, series-wound universal motor can be controlled easily when working under household power supply which is 50 or 60 hertz sine wave alternating current.

The most commonly used electronic speed control devices for series-wound universal motor working under household power supply is the phase control by thyristor. By phase control the thyristor switches on the power supply at a conduction angle ranged between 0 degree to 180 degree of the sine wave alternating current supply. A conduction angle of 180 degree corresponds to full conduction while the conduction angle of 0 degree means totally turn off.

A thyristor turns off at every half cycle of the sine wave alternating current supply makes the control very simple, only a timing device synchronizing the sine wave alternating current supply is needed to trigger the thyristor at the required conduction angle. A conduction angle is a function of time for a fixed supply frequency.

The speed of the series-wound universal motor is a function of supply current and torque. By controlling the conduction angle of the thyristor speed of the series-wound universal motor can be controlled smoothly.

If there exist a set of optimum blade speed variation for various food texture represented as curves, then if the thyristor is triggered at the conduction angle as indicated in the curves, the desired food texture can be obtained. Practically curves for various food textures can be obtained from tables stored in memory device, or they can be determined by computing devices that connect directly to sensors tracing the related physical quantities representing the food texture.

The current that flows through the series-wound universal motor under normal start up condition contributes to the starting magnetic flux that produces the starting torque. Before the building up of the magnetic flux the coils of the series-wound universal motor behaves like a resistance that the instantaneous start up current is very high. After the building up of the magnetic flux and the back electric motive force generated by the armature rotation, the current drops to normal operating level. Actually portion of the high start up current is dissipated as heat energy after the magnetic flux is saturated. By providing a soft start sequence that provides only the effective current to the series-wound universal motor starting up of the motor can be safe and effective, especially for blender that maximum load is already applied during start up.

Further to the start up sequence protection, the series-wound universal motor may be damaged if working under improper condition; the operating current flows through the series-wound universal motor can boost up multiple times the rated current if the motor is prevented from rotating.

To protect it from happening, thermal fuse or thermostat is introduced. Protection by thermal detection may be a thermostat that is placed inside the coil of the stator. A thermostat reacts when its temperature reaches a rated temperature. The temperature of the thermostat is the resultant heat energy conducted to it from the adjacent coil winding. Protection by thermal detection may also be a thermal fuse that cut off the power supply after reaching a rated temperature. This is not a preferred solution since the thermal fuse has to be replaced.

Protection by thermal detection is not effective, in fact before a thermostat can take action permanent damage that shortens the life of the motor may already occurred. Firstly multiple times over the rated current passing through the coils may heat up and melt down the insulation material of the coil before the thermostat could react. Secondly the rotor may heat up to a different temperature that measuring only the stator coil temperature cannot protect the rotor effectively. Accumulative damages of the insulation material shorten the motor life, the fact that the thermostat turns on the power again after its temperature falls below the rated temperature damages an unattended blender working under improper condition more seriously.

By introducing the food texture control to blenders the food prepared by the blender may be more suitable for different users such as babies, patients with swallowing difficulties, people enjoying drinks with crunchy particles, etc. In order to achieve food texture control the speed of the series-wound universal motor is controlled by thyristor that is triggered at the conduction angle as indicated by the selected speed variation curve. In case of improper operating condition, much faster physical signals such as temperature, current sensing can effectively turn off the power supply by stopping the triggering to the thyristor.

An Object of the invention is therefore to provide a food texture control and protection system for electric motor powered blender that provides more variations in food texture; the controlling device provides effective protection to the blender.

### SUMMARY OF THE INVENTION

The invention provides a food texture control and protection system for electric motor powered blender including a speed control device adapted to receive a selection signal that is generated by an input device, wherein the blade of the said blender rotates according to the selected speed variation against time curve.

The said blade is mechanically coupled to an electric motor that is powered by the household sine wave power supply and is controlled by a phase control device,

The said electric motor is a series-wound universal motor which rotation speed is a function of the effective electric current supplied to it, wherein the said effective electric current is the effective power supplied to it which is controlled by the said phase control device. The said phase control device is capable to control every half cycle of the said household sine wave power supply by turning on a thyristor at a conduction angle ranging within the half cycle of the said household sine wave power supply.

The said thyristor of the said phase control device conducts at the said conduction angle wherein a conduction angle of 180 degrees means having the half cycle of the said power supply totally turned on while a conduction angle of 0 degree means totally turned off respectively.

For the said household sine wave power supply of fixed frequency, the said conduction angle is a function of time. If the said frequency is 50 hertz, the said conduction angle ranging from 180 degrees to 0 degree corresponds to the range from 0 millisecond to 10 milliseconds start measuring from the start of a half cycle.

The said speed of the said series-wound universal motor is a function of the said conduction angle, said conduction angle is controlled by a trigger timing device in the said phase control device. The said trigger timing device triggers the said thyristor in the said phase control device at the trigger time according to the preset speed variation against time curve, wherein the said trigger time is measured from the start of a half cycle.

Conventionally the peak current that flows through the said series-wound universal motor during start up may be multiple times the rated current because it has to start up with the maximum load applied. The said speed variation against time curve at start up may be preset according to a soft start sequence that controls the current flowing through the said series-wound universal motor during start up. Instead of supplying the full power to the said series-wound universal motor during start up the said phase control device steps up the power supply to the said series-wound universal motor in sequence as controlled by the said soft start sequence. The said start up sequence effectively provides sufficient energy for the generation of the magnetic flux without driving the said series-wound universal motor to magnetic saturation or resistive power dissipation that caused from excessive current.

The food texture control and protection system for electric motor powered blender may have multiple speed variation against time curves stored as table in the device, these curves may include curve for baby food preparation; curve for patient with swallowing difficulties; curve for drinks with crunchy particles, etc. In some embodiments, more curves can be stored; curve value can be tailor-made to food texture by users.

The food texture control and protection system for electric motor powered blender may have manual or automatic curve selection. In some embodiments, curves can be selected by manual switches in the said input device or automatically by the device computation algorithm.

The food texture control and protection system for electric motor powered blender may have a computing device which can determine the optimum speed variation against speed curve directly from the data obtained by the sensors tracing the food texture related physical quantities.

The food texture control and protection system for electric motor powered blender further adapted to receive the motor condition physical signal from sensors that track the operating condition of the said series-wound universal motor. The said physical signal may be the stator coil temperature of the said series-wound universal motor that is detected by a thermistor that responds quickly to the temperature changes.

The said physical signal may be the current supplied to the said series-wound universal motor that is detected by a voltage drop across a resistance connecting in series with the said series-wound universal motor.

The said physical signal may be the current supplied to the said series-wound universal motor that is detected by a current transformer with one of the winding connected in series with the said series-wound universal motor.

Upon the detection of an improper operating condition the food texture control and protection system for electric motor powered blender turns off the power supplied to the said series-wound universal motor by stop triggering the said thyristor of the said phase control device.

### BRIEF DESCRIPTION OF THE DRAWINGS

Embodiments of the invention will now be described by way of example only and with reference to the accompanying drawing, in which:

FIG. 1 shows a block diagram of the related signal of the food texture control and protection system for electric motor powered blender according to the first embodiment of the present invention;

FIG. 2 shows a block diagram of the related function of the food texture control and protection system for electric motor powered blender according to the first embodiment of the present invention;

FIG. 3 shows a block diagram of the related signal of the food texture control and protection system for electric motor powered blender according to the second embodiment of the present invention;

FIG. 4 shows a block diagram of the related function of the food texture control and protection system for electric motor powered blender according to the second embodiment of the present invention;

FIG. 5a shows the current against time curve of motor during conventional start up.

FIG. 5b shows the current against time curve of motor with soft start sequence during start up.

FIG. 6 shows the speed variation against time curve for fiber enriched food.

### DETAILED DESCRIPTION OF THE PREFERRED EMBODIMENTS

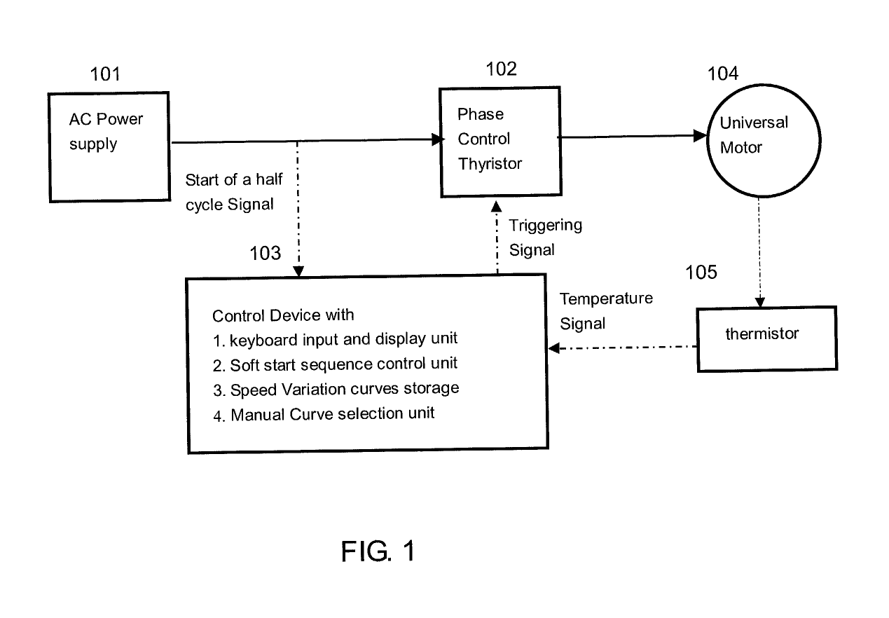

FIG. 1 shows a block diagram of the related signal of the food texture control and protection system for electric motor powered blender according to the first embodiment of the present invention.

In this embodiment, a series-wound universal motor 104 is powered by the household sine wave alternating current power supply 101. A phase controlled thyristor 102 switches on the power supply 101 to the motor 104 according to a triggering signal that is a pulse sequence generated by a control device 103.

The control device 103 receives a start of a half cycle signal from the power supply 101 that serves as the timing reference for the pulse sequence generation. The control device 103 generates the said triggering signal according to a soft start sequence and then a speed variation against time curve as selected by a keyboard. In case the temperature signal detected by a thermistor that is embedded in coil of the motor 104 indicates that the operation is dangerous, the control device 103 terminates the triggering signal.

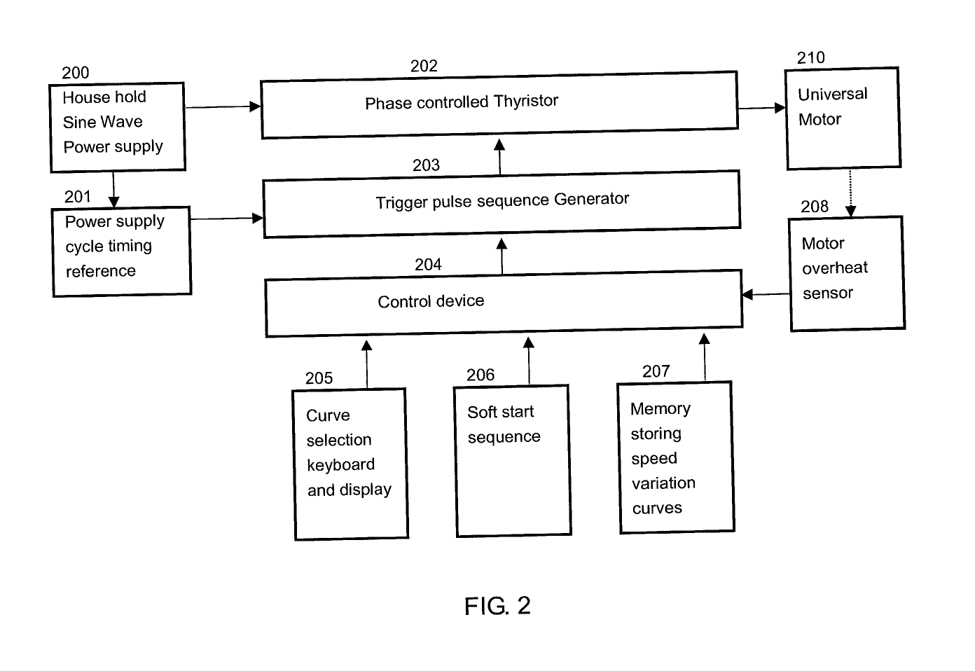

FIG. 2 shows a block diagram of the related function of the food texture control and protection system for electric motor powered blender according to the first embodiment of the present invention.

The series-wound universal motor 210 is powered by the household sine wave alternating current power supply 200. A phase controlled thyristor 202 is controlled by a pulse sequence generated by a trigger sequence generator 203.

The power supply cycle timing reference 201 occurs at 0 degree and 180 degrees of the sine wave of the power supply 200, said timing reference 201 marks the start of every half cycle of the power supply 200.

The trigger sequence generator 203 produces a trigger pulse at a time delay from the timing reference 201. For a 50 hertz sine wave power supply, said time delay is ranged from 0 millisecond to 10 millisecond. A time delay of 0 millisecond means triggering the phase controlled thyristor at the beginning of the half cycle while a time delay of 5 millisecond means triggering the phase controlled thyristor at 90 degrees.

The time delay is supplied by the control device 204 that determines the time delay during start up by referring to the soft start sequence 206, the time delay corresponds to the keyboard 205 selected speed variation curve by looking up table stored in memory 207. The control device 204 disables the trigger sequence generator 203 that stops the generation of the triggering pulse sequence when an improper operation condition as detected by the Motor overheat sensor 208 has occurred.

The first embodiment is a low cost embodiment employing the present invention.

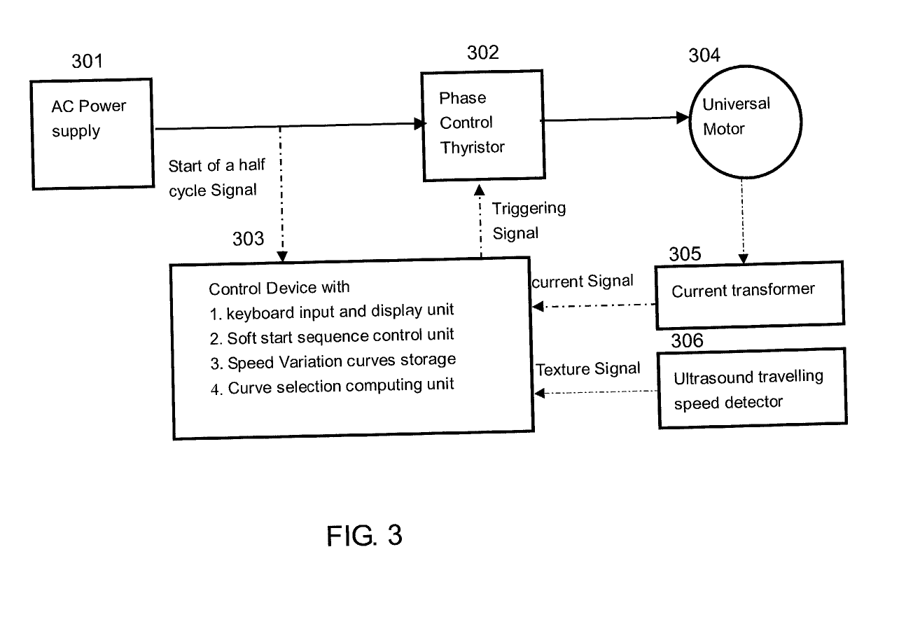

FIG. 3 shows a block diagram of the related signal of the food texture control and protection system for electric motor powered blender according to the second embodiment of the present invention.

All signals except the temperature signal as in the first embodiment are provided, the temperature signal is replaced by a current signal that is generated by a current transformer 305 that detects the current flows through the motor 304.

Current signal generated by the current transformer 305 is used for the detection of the improper operation of condition of the universal motor 304.

In addition, ultrasound travelling speed detection transceiver 306 that measures the speed of the ultrasound and the energy absorbed by the food texture are introduced to provide the texture signal such that automatic speed variation curve selection can be performed by the control device 303.

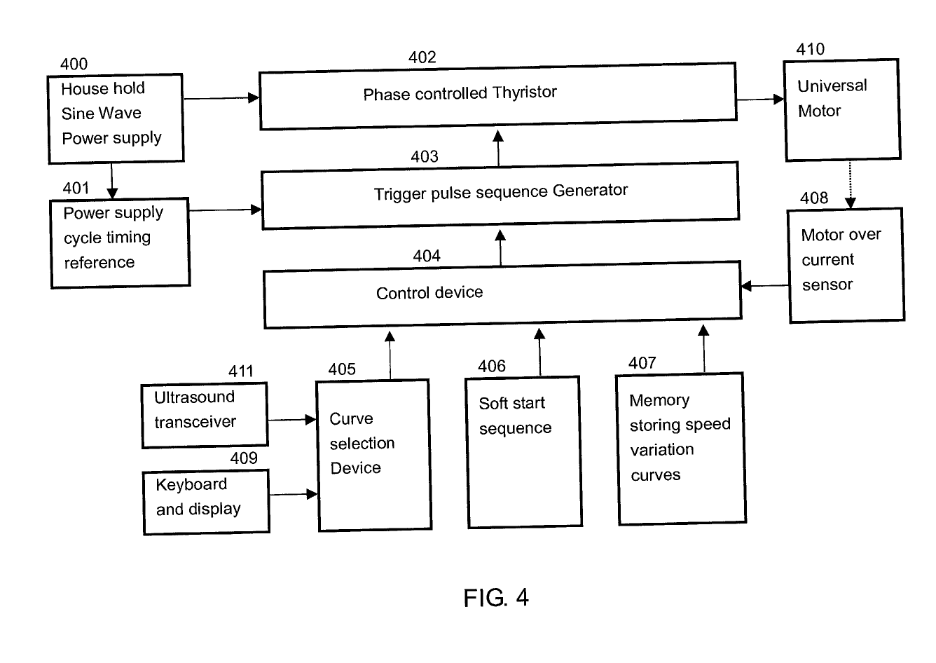

FIG. 4 shows a block diagram of the related function of the food texture control and protection system for electric motor powered blender according to the second embodiment of the present invention.

All functions as in the first embodiment are provided, together with the following feature.

Current signal generated by the current transformer 305 responds quickly that a highly optimized start up sequence with motor 304 current feed back could be obtained.

The energy of ultrasound absorbed and the speed of ultrasound that traveled in side the food texture can determine the texture of the food being processed; an ultrasound transceiver 408 is introduced to provide such data.

By combining the user keyboard input 409 with the estimation of the food texture being process by the ultrasound transceiver 408, the curve selection device 405 could switch curve such that more desirable texture could be obtained.

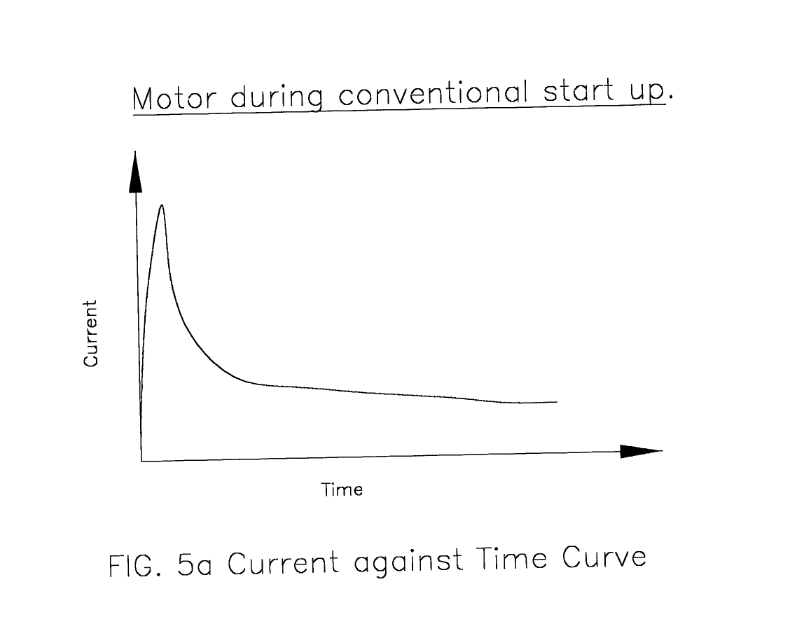

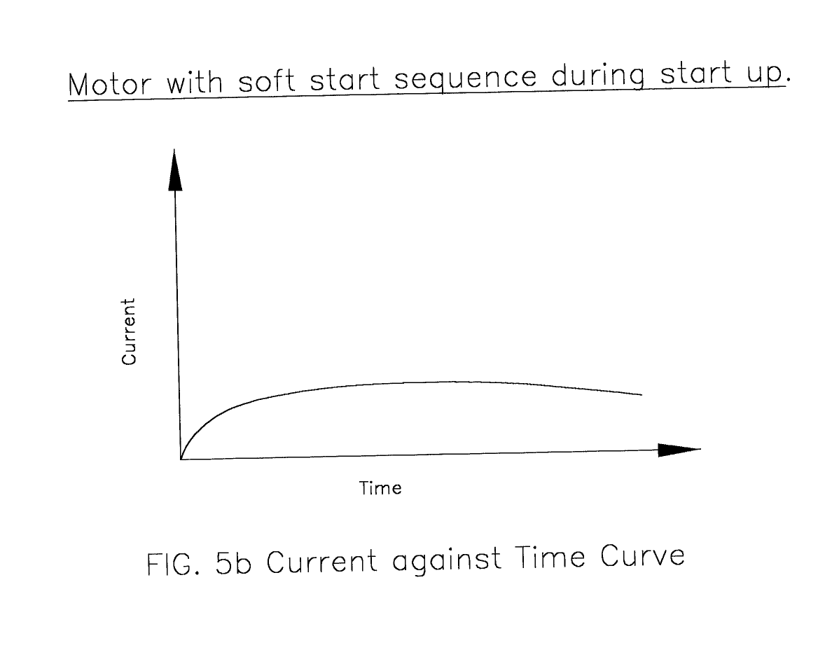

FIG. 5a shows the current against time curve of motor during conventional start up.

FIG. 5b shows the current against time curve of motor with soft start sequence during start up.

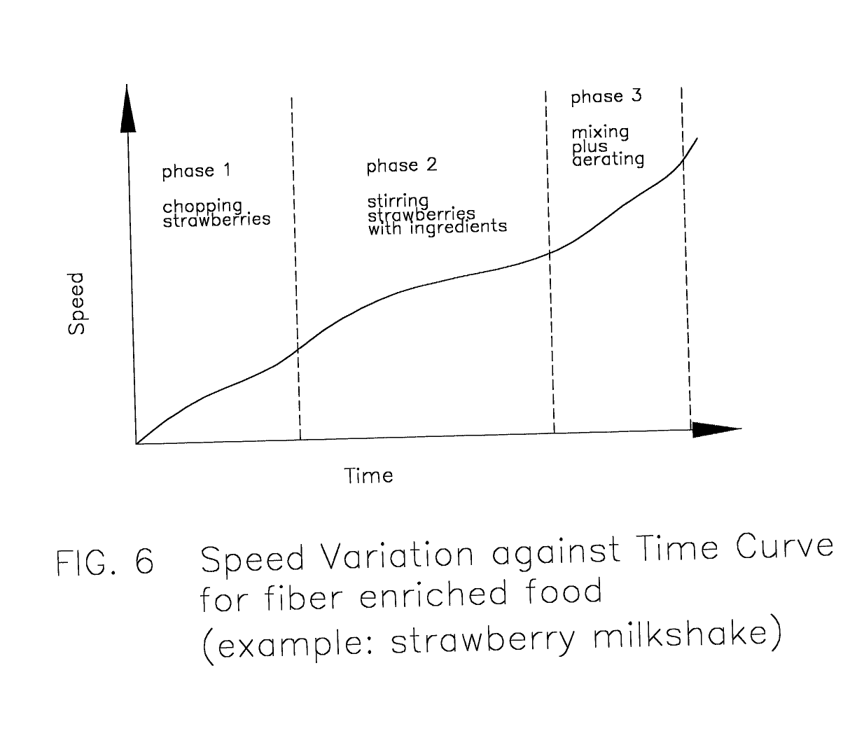

FIG. 6 shows the speed variation against time curve for fiber enriched food.

Other embodiments and variations within the spirit and scope of the invention are anticipated.

What is claimed is:

1. A food texture control and protection system for electric motor powered blender comprising a control device arranged to control the operation of the electric motor, the said electric motor is a series-wound universal motor that generates mechanical energy from the household sine wave alternating current power supply, said control device generates a pulse sequence synchronous with the said power supply and occurs after a time delay from the start of every half cycle of the power supply, said pulse sequence triggers a phase control thyristor device that turns on the power supply to the said electric motor upon triggered until the end of the said half cycle, said time delay controls the effective power supplied to the said electric motor.

2. A food texture control and protection system for electric motor powered blender of claim 1 wherein the said time delay changes according to preset speed variation against time curves stored in memory of the said control device.

3. A food texture control and protection system for electric motor powered blender of claim 2 wherein the said speed variation against time curves start with a soft start sequence that provides sufficient energy for the generation of the magnetic flux without driving the said electric motor to magnetic saturation or resistive power dissipation that caused from excessive current.

4. A food texture control and protection system for electric motor powered blender of claim 3 wherein the said speed variation curves correspond to requirements that contribute to different food textures.

5. A food texture control and protection system for electric motor powered blender of claim 3 wherein said control device further comprising an input device adapted to receive a curve selection signal.

6. A food texture control and protection system for electric motor powered blender of claim 5 wherein the said curve selection signal is generated from manual input.

7. A food texture control and protection system for electric motor powered blender of claim 5 wherein the said curve selection signal is generated from a computation device that determines the best speed variation against time curve from data obtained by sensors that track the food texture related physical quantities.

8. A food texture control and protection system for electric motor powered blender of claim 5 wherein said control device further comprising a protection device that terminates the said pulse sequence after an improper operation condition has been detected.

9. A food texture control and protection system for electric motor powered blender of claim 8 wherein said operation condition is detected by sensing device that tracks the operating temperature of the said electric motor.

10. A food texture control and protection system for electric motor powered blender of claim 8 wherein said operation condition is detected by sensing device that tracks the operating current of the said electric motor.
